(19) United States
(12) Patent Application Publication
(10) Pub. No.: US 2007/0263905 A1
(43) Pub. Date: Nov. 15, 2007

(54) MOTION DETECTION METHOD AND APPARATUS

(76) Inventors: Ching-Hua Chang, Taipei Hsien (TW); Po-Wei Chao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/746,651

(22) Filed: May 10, 2007

(30) Foreign Application Priority Data
May 10, 2006 (TW) 095116547

(51) Int. Cl. G06K 9/00; G06K 9/36; H04N 5/14

(52) U.S. Cl. 382/107; 382/236; 348/699

(57) ABSTRACT

A motion detection apparatus and related method for detecting motions between a first image and a second image are disclosed. The motion detection apparatus includes an edge detection module and a motion detection unit. The edge detection module performs an edge detecting operation on the first and second images so as to categorize a plurality of pixels in the first and second images. The motion detection unit is coupled to the edge detection module. According to the categorizing results of the pixels in the first and second images, the motion detection unit detects motion between the first and second images.

### BACKGROUND OF THE INVENTION

1. Field of the Invention

The present invention relates to image processing, and more particularly, to motion detection of an image.

2. Description of the Prior Art

Motion detection is one of the most used techniques for video processing. The motion detection determines if any image motion occurs at a specific location of the image, or serves as basis for calculating image motion value (e.g., motion vector). The result of motion detection can be used as basis for performing de-interlacing interpolation, or for performing luminance/chrominance separation, or Y/C separation.

The following description is an exemplary de-interlacing calculation. Please refer to FIG. 1. FIG. 1 is a diagram illustrating video data 200 and an output frame 250 corresponding to the video data 200. In FIG. 2, the output frame 250 corresponds to time T, and the four consecutive fields 210, 220, 230, and 240 of the video data 200 correspond to time T−2, T−1, T, and T+1, respectively. The scanning lines 212, 222, 232, and 242 are the (N−1)^{th} scanning line of the fields 210, 220, 230, and 240, respectively. The scanning lines 214, 224, 234, and 244 are the N^{th} scanning line of the fields 210, 220, 230, and 240, respectively. The scanning lines 216, 226, 236, and 246 are the (N+1)^{th} scanning line of the fields 210, 220, 230, and 240, respectively. Each of the above-mentioned scanning lines comprises a plurality of pixels. The output frame 250 is generated by performing a de-interlacing operation on the video data 200.

Normally, the de-interlacing apparatus directly assigns the scanning lines 232, 234, and 236 in the field 230 corresponding to time T as the scanning lines 252, 256, and 260 of the output frame 250. The pixels of scanning lines 254, 258 of the output frame 250 can be generated by performing a de-interlacing calculation upon the video data 200.

For example, for the target pixel 12 of the scanning line 258 of the output frame 250, the de-interlacing apparatus detects the degree of difference between two adjacent fields (e.g., between the fields 220 and 230, and/or between fields 230 and 240) corresponding to the target pixel 12, to determine if any field motion occurs, and further determines whether intra-field interpolation or inter-field interpolation should be applied for generating the target pixel 12. In another example, the de-interlacing apparatus detects the degree of difference corresponding to the target pixel 12 between two counterpart fields in two adjacent frames (e.g., the field 240 at time T+1 and the field 220 at time T−1, which may both be even field of two adjacent frames, or may both be odd fields of two adjacent frames), to determine if any frame motion occurs, and further determines whether intra-field interpolation or inter-field interpolation should be applied for generating the target pixel 12. The above-mentioned degree of difference between two fields corresponding to the target pixel 12 is typically the sum of absolute differences (SAD) between the pixel values of a first pixel group in the one field, which may comprise one or more pixels, corresponding to the target pixel 12 (usually, in the vicinity of, or surrounding, the location in said field which corresponds to the target pixel 12), and the pixel values of a second pixel group in the other field, which may similarly comprise one or more pixels, corresponding to the target pixel 12.

As per the above-mentioned description, when the motion detection calculation is performed, the degree of difference of the pixel values between two groups of pixels is used to determine if any image motion occurs, or for calculating the image motion value. However, as noise always exists in a digital image, errors in the pixel values are easily inflicted. Consequently, if the motion detection is performed only based on the degree of difference of pixel values between two groups of pixel, then erroneous detection result due to noise may be generated, thereby affecting a following image processing operation.

### SUMMARY OF THE INVENTION

Therefore, one of the objectives of the present invention is to provide a motion detection method and apparatus that first performs categorization upon the pixels and then performs motion detection according to the categorization of the pixels.

According to an embodiment of the present invention, a motion detecting method is disclosed. The motion detecting method is utilized for detecting motion between a first image and a second image. The motion detecting method comprises the steps of: performing an edge detecting calculation upon the first and the second images to categorize a plurality of pixels within the first and the second images; and detecting the motion between the first and the second images according to categorizing results of the pixels within the first and the second images.

According to an embodiment of the present invention, a motion detecting apparatus is disclosed for detecting motion between a first image and a second image. The motion detecting apparatus comprises an edge detecting module, and a motion detecting unit. The edge detecting module performs an edge detecting calculation upon the first and the second images to categorize a plurality of pixels within the first and the second images; and the motion detecting unit, coupled to the edge detecting module, detects the motion between the first and the second images according to categorizing results of each of the pixels within the first and the second images.

According to a third embodiment of the present invention, a motion detecting apparatus is disclosed for detecting a motion between a first image and a second image, the motion detecting apparatus comprises an edge detecting module, a pixel window statistic module, and a motion detecting unit. The edge detecting module performs an edge detecting calculation upon the first and the second images to categorize a plurality of pixels within the first and the second images. The pixel window statistic module coupled to the edge detecting module for performing a statistic calculation upon edge categorized results of the pixels within the first and the second images on a pixel window basis to further categorize the pixels within the first and the second images. The motion detecting unit coupled to the pixel window statistic module for detecting the motion between the first and the second images according to further categorizing results of the pixels within the first and the second images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a video data and a corresponding output frame.

FIG. 2 is a diagram illustrating a motion detecting apparatus according to a first embodiment of the present invention.

FIG. 3 is a flow chart illustrating the operation of the motion detecting apparatus as shown in FIG. 2.

FIG. 4 is a diagram illustrating a motion detecting apparatus according to a second embodiment of the present invention.

FIG. 5 is a flow chart illustrating the operation of the motion detecting apparatus as shown in FIG. 4.

FIG. 6 is an exemplary table illustrating the categorizing rule of the first pixel window statistic unit as shown in FIG. 4 where M=N=5.

### DETAILED DESCRIPTION

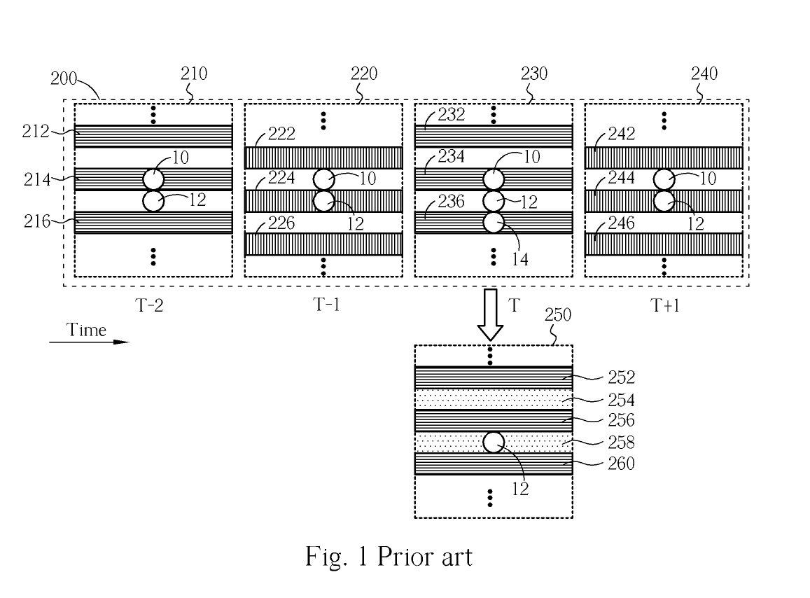

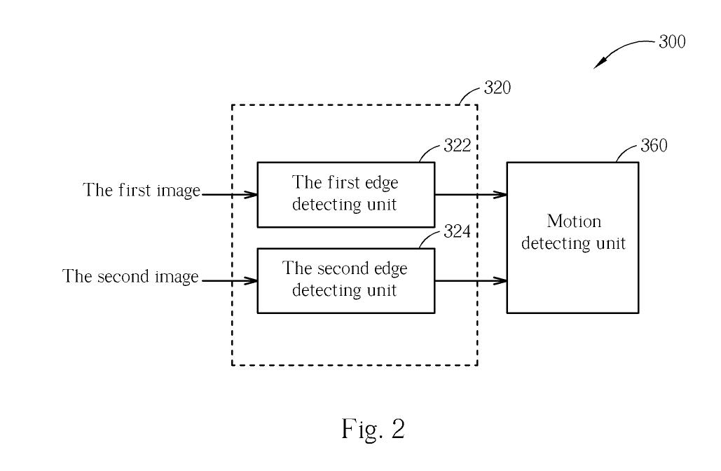

Please refer to FIG. 2. FIG. 2 is a diagram illustrating a motion detecting apparatus 300 according to a first embodiment of the present invention. The motion detecting apparatus 300 is used for detecting motion between a first image and a second image. For example, the first and the second images may be two adjacent fields (e.g., the fields 220, 230, or the fields 230, 240 as shown in FIG. 1). Alternatively, the first and the second images may also be two counterpart fields of two frames respectively(e.g., the fields 220, 240 as shown in FIG. 1).

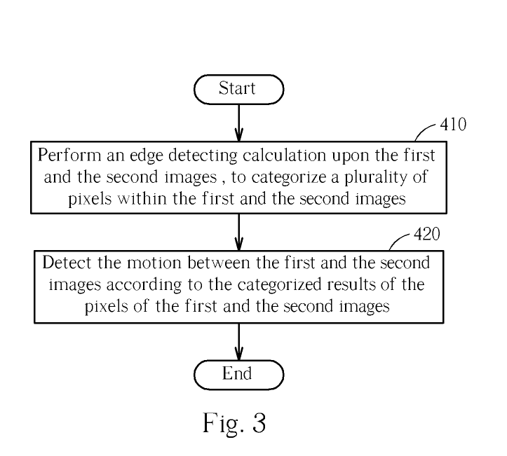

The motion detecting apparatus 300 comprises an edge detecting module 320 and a motion detecting unit 360, wherein the edge detecting module 320 comprises first and second edge detecting units 322, 324 for receiving the first image and the second image respectively. FIG. 3 is a flow chart illustrating an example of the operation of the motion detecting apparatus 300, and described as the following steps:

Step 410: The edge detecting module 320 performs an edge detecting calculation upon the first and the second images, to categorize a plurality of pixels within the first and the second images. In this embodiment, the first edge detecting unit 322 comprises one or more edge detecting filters, such as Sobel filter(s) or Laplace filter(s). For a pixel of the first image, the first edge detecting unit 322 can determine the edge type of the pixel through the operation of the edge detecting filter. For example, in this embodiment the first edge detecting unit 322 can categorize the pixels into one of five types, which are non-edge type, horizontal edge type, right-oblique edge type, vertical edge type, and left-oblique edge type. Each edge type can be represented by a specific edge categorization value. For example, the first edge detecting unit 322 uses the numbers of “0”, “1”, “2”, “3”, and “4” to represent the non-edge type, horizontal edge type, right-oblique edge type, vertical edge type, and left-oblique edge type, respectively. In other words, when a pixel of the first image is determined as a non-edge type, the first edge detecting unit 322 assigns “0” to be the edge categorization value of said pixel, and outputs the “0” to the motion detecting unit 360. When a pixel of the first image is determined as a vertical edge type, the first edge detecting unit 322 assigns “3” to be the edge categorization value of the pixel, and outputs the “3” to the motion detecting unit 360. As the function of the second edge detecting unit 324 is similar to the function of the first edge detecting unit 322, which is to perform the categorization upon the second image, the detailed description of the second edge detecting unit 324 is herein omitted. Please note that, using numbers “0”, “1”, “2”, “3”, and “4” to represent the edge categorization value of the first and the second edge detecting units 322, 324 merely serves as an example. In other words, other numbers can be used for representing the edge categorization value of the first and the second edge detecting units 322, 324.

Step 420: The motion detection unit 360 detects the motion between the first and the second images according to the categorized results of the pixels of the first and the second images (i.e., the edge categorization value of the plurality of pixels within the first and the second images in this embodiment). If the first and the second images are the fields 220, 230 of the FIG. 1 respectively, then in step 410, the first and the second edge detecting units 322, 324 output the edge categorization value of each pixel within the fields 220, 230 respectively. In step 420, the motion detecting unit 360 then calculates a sum of absolute differences (SAD) between the edge categorization values of a group of pixels within the field 220 and the edge categorization values of another group of pixels within the field 230, and then determines if any motion occurs between the field 220 and the field 230 (e.g., if the calculated SAD is larger than a predetermined threshold value, then it is determined that motion occurred between the field 220 and the field 230). Furthermore, the result of the motion detecting unit 360 is provided to subsequent circuit (e.g., de-interlacing compensation unit, luminance-chrominance separating unit, or other video processing unit) for their utilization or reference.

Please note that, in step 420 other algorithms or calculated indications similar to SAD can also be used, so that the resulting accumulating value will represent the tendency of the motion more clearly. For example, as the difference between a non-edge type and various types of edge is quite obvious, when the categorized edge values of the first image and the second image are respectively detected as “0” and “1”˜“4”, or vice versa, a 3 can be added into the accumulating value. As the difference between the vertical edge type and the horizontal edge type, and the difference between the left-oblique edge type and the right-oblique edge type are rather obvious, when the categorized edge values of the first image and the second image are respectively detected as “1” and “3”, or as “2” and “4”, or vice versa, a 2 can be added into the accumulating value. As the difference between the horizontal edge type and the right/left-oblique edge types, and the difference between the vertical edge and the right/left-oblique edges are comparatively small, when the categorized edge values of the first image and the second image are respectively detected as “1” and “2”, “1” and “4”, “3” and “2”, or “3” and “4”, or vice versa, a 1 can then be added into the accumulating value. Furthermore, if the categorized edge values of the first image and the second image are detected to be the same, then no value will be added to the accumulating value. Accordingly, if the accumulating value is relatively large, this represents that the motion tendency is more obvious. Please note that, in step 420, calculating the SAD value or utilizing the above-mentioned accumulating value to detect the motion merely serves as an example of the present invention, and is not meant to be limiting.

In this embodiment, because the motion detecting unit 360 performs the calculation of motion detection according to the categorized edge value of a plurality of pixels within the first and the second images, but not directly according to the original pixel value of the plurality of pixels within the first and the second images, and the categorized edge value that obtained by performing the edge detecting operation upon a pixel value will has a higher noise resistivity than the original pixel value of respective pixel, the motion detecting apparatus 300 of this embodiment has a more precise motion detecting ability than prior technology. In other words, even though the received pixel value may be affected by noise and contaminated with error, the motion detecting apparatus 300 of this embodiment can nevertheless obtain a more precise motion detecting result.

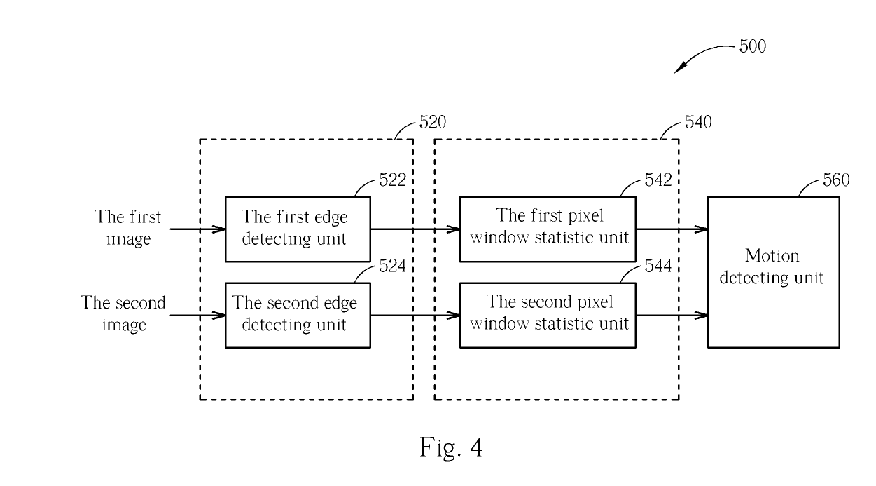

Please refer to FIG. 4. FIG. 4 is the second embodiment of the motion detecting apparatus according to the present invention. The motion detecting apparatus detects the image motion between a first image and a second image. For example, the first and the second images are two adjacent images (e.g. the fields 220, 230, or the fields 230, 240 as shown in FIG. 1). Furthermore, the first and the second images can also be the two counterpart fields (e.g., both being even fields or both being odd fields) in two frames (e.g., the fields 220, 240 as shown in FIG. 1).

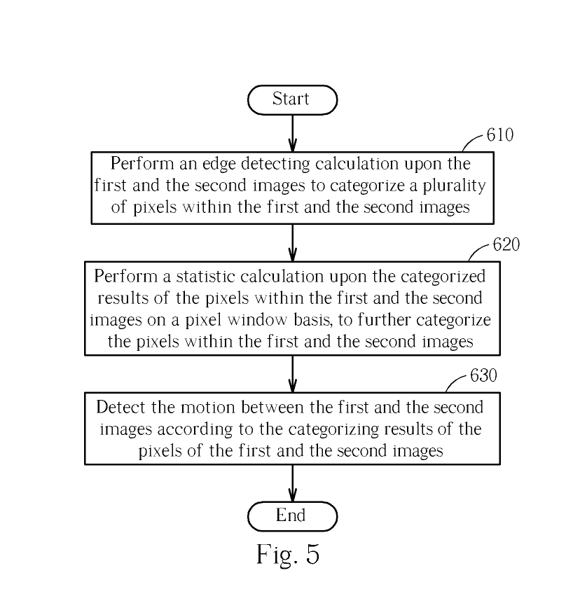

The motion detecting apparatus 500 comprises an edge detecting module 520, a pixel window statistic module 540, and a motion detecting unit 560. The edge detecting module 520 comprises a first and a second edge detecting units 522, 524. The pixel window statistic module 540 comprises a first and a second pixel widow statistic units 542, 544. FIG. 5 is a flow chart illustrating an example of the operation of the motion detecting apparatus 500, and described as the following steps:

Step 610: The edge detecting module 520 performs an edge detecting calculation upon the first and the second images to categorize a plurality of pixels within the first and the second images. As the operation of the edge detecting module 520 of this embodiment is similar to the operation of the first and the second edge detecting units 322, 324 in the edge detecting module 320, the detailed description is omitted herein for brevity.

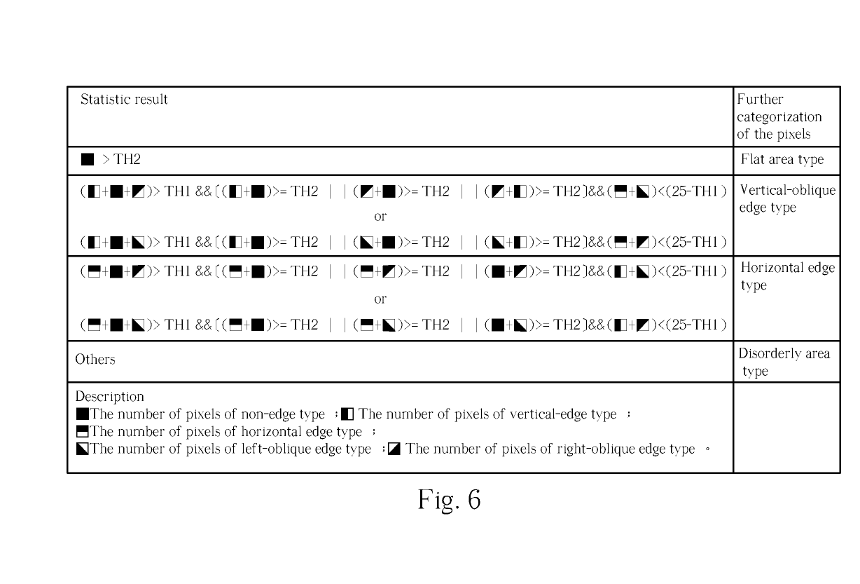

Step 620: The pixel window statistic module 540 performs a statistic calculation upon the categorized results of the pixels within the first and the second images on a pixel window basis, to further categorize the pixels within the first and the second images. As wrongful categorization may occur when the edge detecting module 520 performs the edge detecting calculation (e.g., wrongfully categorizing a disorderly pixel, or pixel without an edge characteristic, as a vertical edge type, or wrongfully categorizing a right-oblique edge type as a horizontal edge type), this embodiment therefore utilizes the pixel window statistic module 540 to perform a statistic operation on the edge detecting result of the edge detecting module 520, to further adjust and then generate a more precise categorized result. More specifically, for a specific pixel in the first image, the first pixel window statistic unit 542 assigns the pixels falling within a specific pixel window of the first image as the objects of performing a statistic operation, and calculate the number of the pixels of each category, or type of edge, in the specific pixel window. Then, the first pixel window statistic unit 542 further categorizes said specific pixel according to the result of the statistic operation. For example, the pixel window can be a pixel window that has M*N pixels and has a center of the specific pixel (M and N are integers not smaller than 1). FIG. 6 is a table illustrating the exemplary categorization rule of the first pixel window statistic unit 542 when M=N=5, wherein TH1 and TH2 are threshold values lying between 1 and 25, and the vertical-oblique edge type is a collection of the vertical edge type, the left-oblique edge type, and the right-oblique edge type. In the example shown in FIG. 6, if the first edge detecting unit 522 determines that a specific pixel is of the vertical edge type, but the first pixel window statistic unit 542 determines that in the specific pixel corresponding to the pixel window the number of pixels of non-edge type is larger than TH2, then the first pixel window statistic unit 542 corrects the categorizing result with respect to the specific pixel performed by the first edge detecting unit 522, and then categorizes the specific pixel as a flat area pixel. If the first edge detecting unit 522 determines that a specific pixel is of the horizontal edge type, but the first pixel window statistic unit 542 determines that the categorizing results of the pixels within the pixel window corresponding to the specific pixel do not match the supposed categorizing results of the flat area type, the vertical-oblique edge type, or the horizontal edge type, then the first pixel window statistic unit 542 corrects the categorized result determined by the first edge detecting unit 522, and then categorizes the specific pixel as the disorderly pixel type. Similarly, after the categorization performed by the first pixel window statistic unit 542, each categorized result can be represented by a specific statistic categorized value. For example, the four different numbers “0”, “1”, “2”, and “3” can respectively represent the statistic categorized values that correspond to the categorized results of the flat area type, the vertical-oblique edge type, the horizontal edge type, and the disorderly pixel type. When a pixel in the first image is further categorized as the disorderly pixel type, the first pixel widow statistic unit 542 can use a “3” to be the statistic categorized value of the pixel, and output “3” to the motion detecting unit 560; when a pixel in the first image is further categorized as the horizontal edge type, the first pixel widow statistic unit 542 can use a “2” to be the statistic categorized value of the pixel, and output “2” to the motion detecting unit 560. Because the function of the second pixel window statistic unit 544 is similar to the function of the first pixel window statistic unit 542, the detailed description of the second pixel window statistic unit 544 is omitted herein for brevity. Please note that using the numbers of “0”, “1”, “2”, and “3” to represent the statistic categorized values of the first and the second pixel window statistic units 542, 544 merely serves as an example. In other words, other numbers can be chosen for representing the statistically categorized values of the first and the second pixel window statistic units 542, 544.

Step 630: The motion detection unit 560 detects the motion between the first and the second images according to the categorizing results of the pixels of the first and the second images (i.e., the statistic categorized value of the pixels within the first and the second images). If the first and the second images are the fields 220, 230, respectively, as shown in FIG. 1, then in step 610, the first and the second edge detecting units 522, 524 respectively output the categorized edge values of each pixel within the fields 220, 230. In step 620, the first and the second pixel window statistic units 542, 544 respectively output the statistic categorized values of each pixel within the fields 220, 230. In step 630, the motion detecting unit 560 calculates a sum of absolute differences (SAD) between the statistic categorized values of a group of pixels within the field 220 and the statistic categorized values of another group of pixels within the field 230, and then detect if any motion occurs between the field 220 and the field 230. For example, if the calculated SAD is larger than a predetermined threshold value, then it can be determined that the motion occurred between the field 220 and the field 230. Furthermore, the result of the motion detecting unit 560 is provided to subsequent circuitry, for example, a de-interlacing compensation unit, a luminance-chrominance separating unit, or other video processing unit, for their reference.

Please note that, in step 630 other algorithms or calculated indications similar to SAD can also be used, so that the resulting accumulating value will represent the tendency of the motion more clearly. For example, as the difference between the flat area type and the disorderly area type is quite obvious, when the statistic categorized values of the first image and the second image are respectively detected as “0” and “3”, then a 3 can be added into the accumulating value. As the difference between the flat area type and the vertical-oblique/horizontal edge type is rather obvious, when the statistic categorized values of the first image and the second image are respectively detected as “0” and “1”, or as “0” and “2”, then a 2 can be added into the accumulating value. As the difference between any two types from the vertical-oblique edge type, the horizontal edge type, and the disorderly area type is quite small, when the statistic categorized values of the first image and the second image are respectively detected as “1” and “2”, as “1” and “3”, or as “2” and “3”, then a 1 can be added into the accumulating value. Furthermore, if the statistic categorized values of the first image and the second image are detected to be the same, then no value will be added to the accumulating value. Accordingly, if the accumulating value is relatively large, this represents that the motion tendency is more obvious. Please note that, in step 630, calculating the SAD value or using the above-mentioned accumulating value to detect the motion merely serves as an example of the present invention, and is not meant to be limiting.

In this embodiment, the motion detecting unit 560 performs the calculation of motion detection according to the statistic categorized value of the pixels within the first and the second images but not directly according to the original pixel value of the pixels within the first and the second images, and the statistic categorized value obtained by performing the edge detecting operation and pixel window statistic calculation upon a pixel value will have a higher noise resistivity than the original pixel value of the respective pixel, the motion detecting apparatus 500 of this embodiment has a more precise motion detecting ability than prior technology. In other words, even if the received pixel value is affected by noise and has some error, the motion detecting apparatus 500 of this embodiment can still obtain a more precise motion detecting result.

Please note that although in the above-described two embodiments the motion detecting apparatus 300, 500 are both applied for motion detection calculation of interlaced type video data, system designers can also use the motion detecting apparatus of the present invention to perform the motion detecting calculation upon the non-interlaced type video data, e.g., progressive type video data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motion detecting method, for detecting a motion between a first image and a second image, the motion detecting method comprising:
performing an edge detecting calculation upon the first and the second images to categorize a plurality of pixels within the first and the second images; and
detecting the motion between the first and the second images according to categorizing results of the pixels within the first and the second images.

2. The motion detecting method of claim 1, wherein the step of performing the edge detecting calculation upon the first and the second images to categorize the pixels within the first and the second images comprises:
assigning an edge categorization value to each of the pixels within the first and the second images according to calculating result of the edge detecting calculation.

3. The motion detecting method of claim 2, wherein the step of detecting the motion between the first and the second images according to the categorizing result of the pixels within the first and the second images comprises:
checking differences between the edge categorization values of a first group of pixels within the first image and the edge categorization values of a second group of pixels within the second image.

4. The motion detecting method of claim 2, wherein the step of detecting the motion between the first and the second images according to the categorizing result of the pixels within the first and the second images comprises:
calculating a sum of absolute differences between the edge categorization values of a first group of pixels within the first image and the edge categorization values of a second group of pixels within the second image.

5. The motion detecting method of claim 2, wherein the step of detecting the motion between the first and the second images according to the categorizing result of the pixels within the first and the second images comprises:
performing a statistic calculation upon the edge categorization values of the pixels within the first and the second images on a pixel window basis to further categorize the pixels within the first and the second images; and
detecting the motion between the first and the second images according to further categorizing results of the pixels within the first and the second images.

6. The motion detecting method of claim 5, wherein the step of performing the statistic calculation upon the edge categorization values of the pixels within the first and the second images on the pixel window basis to further categorize the pixels within the first and the second images comprises:
assigning a statistic categorization value to each of the pixels within the first and the second images according to the calculating result of the statistic calculation upon the edge categorization values of the pixels within the first and the second images on the pixel window basis.

7. The motion detecting method of claim 6, wherein the step of detecting the motion between the first and the second images according to the further categorizing results of the pixels within the first and the second images comprises:
checking a difference between the statistic categorization values of a first group of pixels within the first image and the statistic categorization values of a second group of pixels within the second image.

8. The motion detecting method of claim 6, wherein the step of detecting the motion between the first and the second images according to the further categorizing results of the pixels within the first and the second images comprises:
calculating a sum of absolute differences between the statistic categorization values of a first group of pixels within the first image and the statistic categorization values of a second group of pixels within the second image.

9. The motion detecting method of claim 5, wherein the step of performing the statistic calculation upon the edge categorization values of the pixels within the first and the second images on the pixel window basis to further categorize the pixels within the first and the second images comprises:
for a specific pixel within the first or the second image, performing a statistic upon the amounts of pixels that are categorized into various types in a specific pixel window, and then categorizing the specific pixel according to a statistic result, wherein the specific pixel window corresponds to the specific pixel.

10. A motion detecting apparatus, for detecting a motion between a first image and a second image, the motion detecting apparatus comprising:
an edge detecting module, for performing an edge detecting calculation upon the first and the second images to categorize a plurality of pixels within the first and the second images; and
a motion detecting unit, coupled to the edge detecting module, for detecting the motion between the first and the second images according to categorizing results of the pixels within the first and the second images.

11. The motion detecting apparatus of claim 10, wherein the edge detecting module assigns an edge categorization value to each of the pixels within the first and the second images according to calculating result of the edge detecting calculation performed upon the first and the second images.

12. The motion detecting apparatus of claim 11, wherein the motion detecting unit checks differences between the edge categorization values of a first group of pixels within the first image and the edge categorization values of a second group of pixels within the second image to detect the motion between the first and the second images.

13. The motion detecting apparatus of claim 11, wherein the motion detecting unit calculates a sum of absolute differences between the edge categorization values of a first group of pixels within the first image and the edge categorization values of a second group of pixels within the second image to detect the motion between the first and the second images.

14. A motion detecting apparatus, for detecting a motion between a first image and a second image, the motion detecting apparatus comprising:
an edge detecting module, for performing an edge detecting calculation upon the first and the second images to categorize a plurality of pixels within the first and the second images;
a pixel window statistic module, coupled to the edge detecting module, for performing a statistic calculation upon edge categorizing results of the pixels within the first and the second images on a pixel window basis to further categorize the pixels within the first and the second images; and
a motion detecting unit, coupled to the pixel window statistic module, for detecting the motion between the first and the second images according to further categorizing results of the pixels within the first and the second images.

15. The motion detecting apparatus of claim 14, wherein for a specific pixel within the first or the second image, the pixel window statistic module performs a statistic upon the amounts of pixels that are categorized into various types in a specific pixel window, and then categorizes the specific pixel according to a statistic result, wherein the specific pixel window corresponds to the specific pixel.

16. The motion detecting apparatus of claim 14, wherein the edge detecting module assigns an edge categorization value to each of the pixels within the first and the second images according to calculation result of the edge detecting calculation performed upon the first and the second images.

17. The motion detecting apparatus of claim 16, wherein the pixel window statistic module assigns a statistic categorization value to each of the pixels within the first and the second images according to the calculation result of the statistic calculation based on the pixel window performed upon the edge categorizing values of the pixels within the first and the second images.

18. The motion detecting apparatus of claim 17, wherein the motion detecting unit checks a difference between the statistic categorization values of a first group of pixels within the first image and the statistic categorization values of a second group of pixels within the second image to detect the motion between the first and the second images.

19. The motion detecting apparatus of claim 17, wherein the motion detecting unit calculates a sum of absolute differences between the statistic categorization values of a first group of pixels within the first image and the statistic categorization values of a second group of pixels within the second image to detect the motion between the first and the second images.
